(19) United States
(12) Patent Application Publication
(10) Pub. No.: US 2006/0082888 A1
(43) Pub. Date: Apr. 20, 2006

(54) Optically reconfigurable light integrator in display systems using spatial light modulators

(76) Inventor: Andrew Huibers, Palo Alto, CA (US)

Correspondence Address: REFLECTIVITY, INC., 350 POTRERO AVENUE, SUNNYVALE, CA, 94085, US

(21) Appl. No.: 11/250,099

(22) Filed: Oct. 12, 2005

Related U.S. Application Data
(60) Provisional application No. 60/620,395, filed on Oct. 19, 2004.

(51) Int. Cl. G02B 27/10

(52) U.S. Cl. 359/627

(57) ABSTRACT

An illumination system for illuminating spatial light modulators of display systems is provided. The illumination comprises a light integrator that comprises at least a movable wall through which the aspect ratio at the exit aperture of the integrator can be adjusted. Alternatively, the illumination system may comprises two juxtaposed light integrators, one of which can be a regular light integrator in prior art, while the other one can be an integrator having at least one movable wall for enabling the adjustment of the aspect ratio at the exit aperture of the integrator. During the operation, one of the juxtaposed integrator is used for collecting and delivering light from the light source according the aspect ratio of the desired image.

### CROSS-REFERENCE TO RELATED CASES

The present US patent application claims priority under 35 U.S.C. §119(e) of co-pending U.S. provisional patent application Ser. No. 60/620,395 filed Oct. 19, 2004, the subject matter being incorporated herein by reference in entirety.

### TECHNICAL FIELD OF THE INVENTION

The present invention is related generally to the art of digital display systems employing spatial light modulators, and, more particularly, to methods and apparatus for illuminating the spatial light modulators of the digital display systems.

### BACKGROUND OF THE INVENTION

Currently, considerable research and business development efforts have arisen applying spatial light modulators, such as liquid-crystals, liquid-crystal-on-silicon and micromirror-based light modulators or the like in display systems. Such applications often require uniform and optically efficient illumination of the spatial light modulators. A challenge in these display systems employing spatial light modulators is displaying images and videos in display system having screens of different aspect ratio. For example, the display systems complying with the NTSC or PAL standards have screens of 4:3 aspect ratio; while the display systems complying with high-definition (HD) or widescreen standards have screens of 16:9 aspect ratio. Display systems often add “black bars” to the horizontal or vertical sides of the screen to display material having an aspect ratio different from the native aspect ratio of the screen. This solution has many disadvantageous. For example, the displayed image, as well as the overall brightness of the displayed image may be reduced. In an example of presenting an image of 16:9 aspect ratio on a screen of 4:3, the added “black bars” on the top and bottom of the screen each typically consume ⅛ of the screen, resulting in a 25% brightness reduction.

Therefore, what is needed is a method and apparatus for illuminating the spatial light modulators of display systems, which can accommodate display material having multiple aspect ratios, and can minimize brightness reduction.

### SUMMARY OF THE INVENTION

In view of the foregoing, the present invention provides a light integrator for use in projection systems, wherein the light integrator comprises a reflecting surface that is operable to pivot along an axis. The axis can be located within the light integrator, or alternatively at an attachment point of an end of the pivotable reflecting surface and an end of a non-pivotable surface, which may or may not be reflective to visible light. The objects and advantages of the present invention will be obvious, and in part appear hereafter and are accomplished by the present invention. Such objects of the invention are achieved in the features of the independent claims attached hereto. Preferred embodiments are characterized in the dependent claims.

### BRIEF DESCRIPTION OF DRAWINGS

While the appended claims set forth the features of the present invention with particularity, the invention, together with its objects and advantages, may be best understood from the following detailed description taken in conjunction with the accompanying drawings of which:

FIG. 1 is a simplified display system in which embodiments of the invention can be implemented;

FIG. 2A is a front view of an exemplary integrator in FIG. 1;

FIG. 2B is a perspective view of the integrator in FIG. 2A;

FIG. 3 is a perspective view of the integrator in FIG. 2A with a side wall removed for clarity purposes;

FIG. 4 demonstratively illustrates the integrator in FIG. 3 under a driving force for optically reconfiguring the integrator;

FIG. 5 demonstratively illustrates the illumination areas before and after the reconfiguration of the light integrator;

FIGS. 6A and 6B demonstratively illustrate the profile of the illumination area before and after the reconfiguration of the light integrator;

FIGS. 7 demonstratively illustrates a solution for the non-uniform illumination in FIG. 6B by providing a light splitter within the light integrator;

FIGS. 8 demonstratively illustrates the profile of the illumination area after providing the light integrator in FIG. 7;

FIGS. 9A and 9B are front views of a light integrator according to another embodiment of the invention;

FIGS. 10 is a top view of two juxtaposed light integrators associated with a non-movable light integrator according for providing uniform and aspect ratio compatible illuminations to the spatial light modulator in FIG. 1; and

FIG. 11 illustrates a cross-sectional view of a light integrator having light absorbing and/or reflective coatings on the exterior surfaces according to the invention.

### DETAILED DESCRIPTION OF THE EMBODIMENTS

The present invention provides a method and apparatus for uniformly and efficiently illuminating spatial light modulators of display systems so as to produce images on display screens with different aspect ratios than those of the desired images. For a given spatial light modulator in a display system having a screen of fixed aspect ratio, the spatial light modulator is illuminated with the illumination area thereon corresponding to the aspect ratio of the desired image. The illumination area is modified through adjustment of the exit aperture of a light integrator. The light integrator of the invention comprises a movable side wall with reflective interior surface. The side wall pivots under a controllable driving force such that the cross-section of the illumination light traveling through the integrator decreases gradually; and the illumination light at the exit aperture of the integrator has a cross-section corresponding to the aspect ratio of the desired image. Specifically, the illumination light exit from the integrator illuminates an area of the spatial light modulator with the illumination area having an aspect ratio equal to the aspect ratio of the desired image.

The integrator of the invention preferably comprises movable side walls that are symmetrically positioned to the center of the integrator. When the interior cross-section of the integrator is rectangular, the top and bottom side walls are preferably movable, and pivots symmetrically under a controllable force relative to the central axis (the symmetrical axis) of the integrator. In operation, the integrator is often placed close to the light source (e.g. arc lamp) of the display system for collecting the light from the light source and delivering the collected light onto the spatial light modulator. The portion of the integrator is thus exposed to the high temperature radiation from the light source. As a consequence, the portion may suffer from distortion. For this reason, the integrator having the movable side walls is joined to an integrator with fixed side walls that tolerate high temperature radiation.

During the course of cross-section transformation and propagation of the illumination light from the entrance aperture to the exit aperture of the integrator, the illumination light also experiences angular transformation, from which the angular distribution of the light at the exit aperture may not be uniform. This is solved by providing a light splitter within the integrator tunnel.

As another aspect of the invention, two or more juxtaposed light integrators having different aspect ratios at the exit apertures are provided to the display system. According to the aspect ratio of the desired image, the integrator having corresponding exit aperture is selected and aligned to the propagation path of the illumination light.

In the following, the present invention will be discussed with examples in which the light integrator has a rectangular cross-section formed by four parallel side walls, two of which are movable. It will be understood by those skilled in the art that the following discussion is for demonstration purposes only, and should not be interpreted as a limitation. Rather, any variations without departing from the spirit of the invention are not intended to be excluded from the invention.

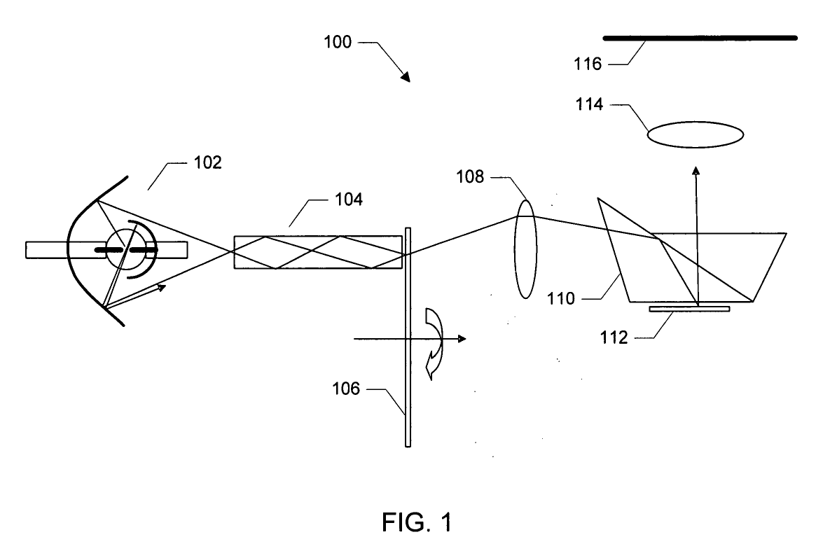

Turning to the drawings, FIG. 1 illustrates a simplified display system in which embodiments of the invention can be implemented. In its basic configuration, display system 100 comprises light source 102, such as an arc lamp, light integrator 104, color wheel 106 that spins during operation, condensing lens 108, prism 110, spatial light modulator 112, projection lens 114 and display screen 116.

During the operation, a light beam is emanated from the light source and collected by the light integrator that delivers the collected light beam onto the spatial light modulator through the color wheel, the condensing lens, and the prism. The color wheel is provided for producing colors, such as the primary colors for the system, and the condensing lens focuses the light beam onto the spatial light modulator. The color light beams shining on the spatial light modulator are then modulated into different spatial directions, specifically onto or away from the projection lens. The modulated color light beams onto the projection lens are then projected onto the screen for displaying the desired image.

It can be seen from the configuration of the above display system that the aspect ratio of the displayed image depends upon the illumination area of the spatial light modulator, and the illumination area is defined by the cross-section of the light beam at the exit of the light integrator, the condensing lens 108, and the relative positions of the exit aperture of the integrator, the condensing lens, and the spatial light modulator. Given the parameters otherwise, which is often the situation in a display system, the cross-section of the exit aperture of the light integrator predominantly determines the aspect ratio of the illumination area of the spatial light modulator, thus the aspect ratio of the displayed image. According to an embodiment of the invention, the integrator of the display system comprises movable walls that pivot during operation such that the cross-section of the exit aperture can be adjusted.

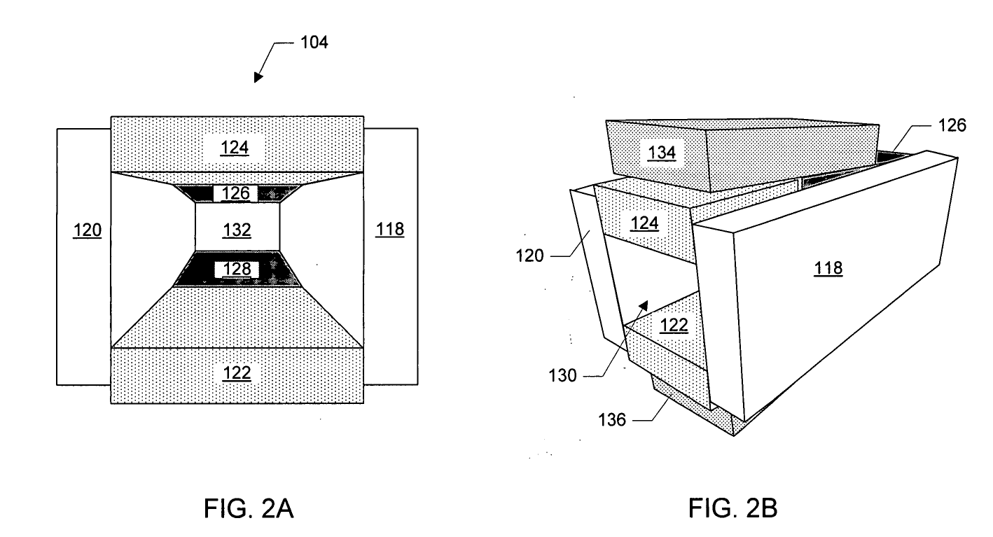

FIG. 2A is a front view of the integrator looking from the entrance. The light integrator comprises side walls 120 and 118, which are fixed in this particular example. The top and the bottom walls of the light integrator each comprise a movable portion and a non-movable portion in conjunction with the movable portion. Specifically, the top wall of the integrator comprises fixed portion 124 and movable portion 126. The bottom wall comprises non-movable portion 122 and movable portion 128. The interior surfaces of the said walls, the top, and the bottom walls are coated with highly reflective material for reflecting the light beam from the light source.

FIG. 2B illustrates a perspective view of the light integrator in FIG. 2A. Side walls 120 and 118 in this particular example are non-movable, while the top and bottom walls each have a movable portion 126 and 128 (not seen). The movable portions are in connection with non-movable portions 124 and 122, respectively. The figure also shows control plate 134 for controlling the movable portion 126, and control plate 136 for controlling the movable portion of 128.

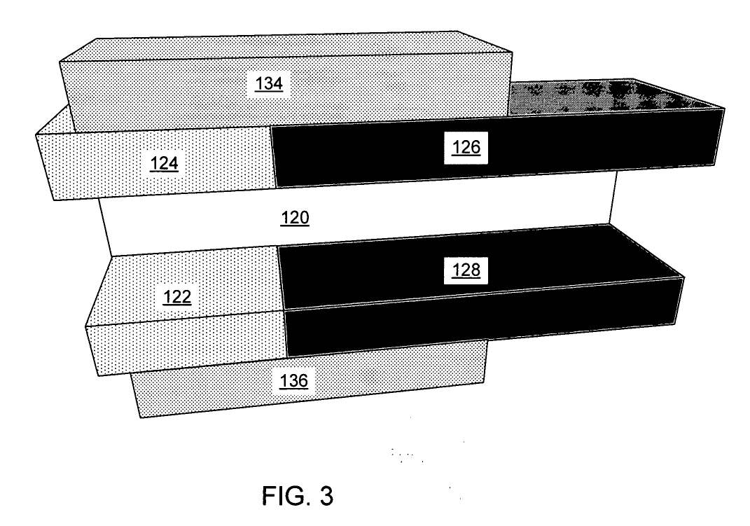

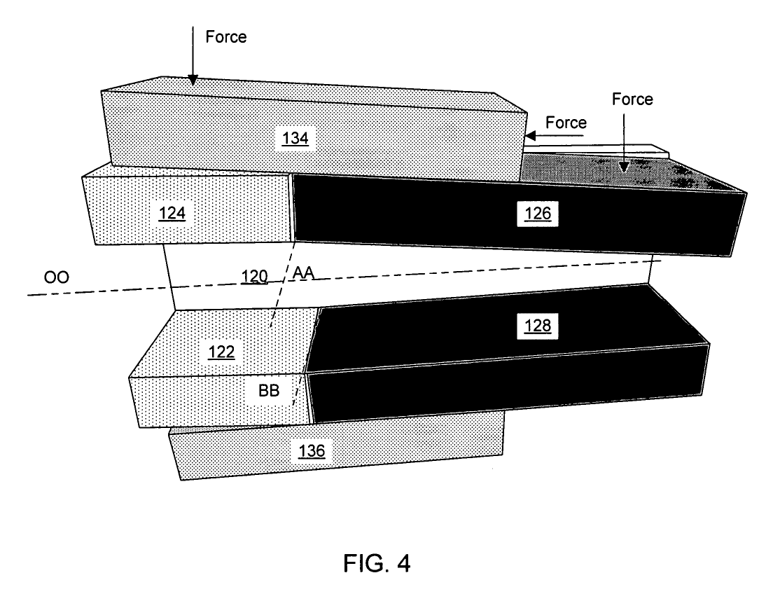

FIG. 3 illustrates the light integrator in FIG. 2B with a side wall removed for clarity. The movable potions 126 and 128 are respectively connected to the non-movable portions 124 and 122. FIG. 4 illustrates the light integrator in FIG. 3 under a driving force. The driving force can be applied to the top surface of plate 134, or laterally on the side of plate 134 so as to move the movable portion 126. Alternatively, the driving force can be directly applied to the top surface of the movable portion 126. Under the driving force, movable portion 126 pivots around axis AA. In fact, more than one driving forces can be applied to the movable portion. For example, the lateral driving force and the driving force to the top surface of the movable portion (and/or plate 134) can be applied at the same time. In particular, the lateral driving force on the side of plate 134 is applied to secure that the movable portion stays against the pivot axis AA. The same driving mechanism for movable portion 126 can be applied to movable portion 128 so as to drive movable portion 128 to pivot around axis BB.

In accordance with the embodiment of the invention, movable portions 126 and 128 pivot symmetrically around the central axis OO of the integrator tunnel. Specifically, the movable portions (126 and 128) pivot towards the central axis for the same angle. Of course, the movements of the movable portions may or may not be synchronized. For example, the movable portions may be moved independently at different times. The angle is determined by the aspect ratio of the desired image. As a way of example, the native aspect ratio of the display system is 4:3 (i.e. aspect ratio of the cross-section at the entrance of the light integrator is 4:3), and the spatial light modulator has a resolution of 1024×768. For display materials (e.g. images or videos) of 4:3 aspect ratio, the movable walls of the integrator are set to unmoved state as shown in FIG. 3. For the display materials of a different aspect ratio, such as 16:9, the movable portions (e.g. 126 and 128 in FIG. 4) are moved to an angle such that exit aperture of the integrator has an aspect ratio of 16:9, and approximately 1024×576 pixels on the spatial light modulator are illuminated. Because the illumination light is directed to the pixels (1024×576) needed to display the desired image rather than those pixels not needed during displaying, no light is wasted therefore. The lumens output of the display system is conserved, and the optical efficiency of the display system is improved. According to the embodiment of the invention, it is highly desired than the interior surface of the movable portions 126 and 128 are smoothly connected to the interior surface of the non-movable portion 124 and 122, respectively such that the interior surfaces of movable portion 126 and non-movable portion 124 form a continuous reflecting surface within the integrator, so as to the interior surfaces of movable portion 128 and non-movable portion 122. Accordingly, the gaps between the movable and the corresponding non-movable portions are minimized. For this reason, a driving force applied laterally to plate 134 is preferably provided. As an alternative feature of the embodiment of the invention, the interior surfaces of the movable portions can be slightly recessed so as to minimize light leakage into a gap between the movable and non-movable portions if any.

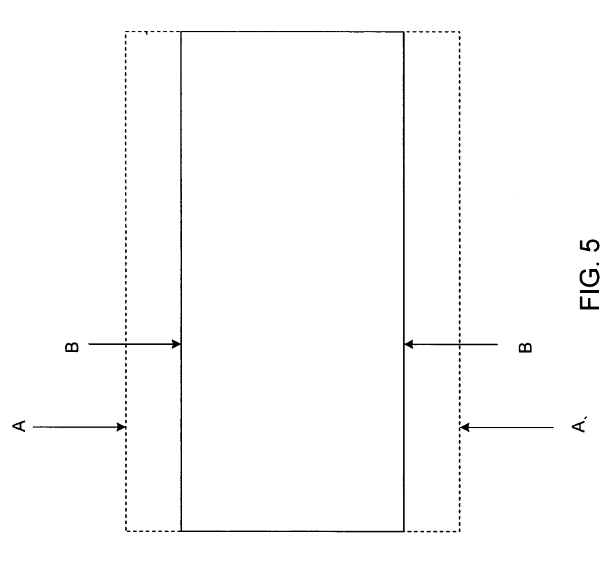

FIG. 5 demonstratively illustrates the reduction effect of the illumination area on the spatial light modulator using the light integrator discussed above. The “AA” plot may represent a 4:3 illumination area on the spatial light modulator produced by the light integrator with the movable walls at their non-moved states (e.g. the integrator in FIG. 3), while the “BB” plot may represent a 16:9 illumination area produced by the integrator with the movable walls moved to a certain angle (e.g. the integrator in FIG. 4). Other values of the aspect ratio are certainly achievable by the integrator with the movable walls at different moving positions. Alternatively, the integrator can be constructed in a display system having the native aspect ratio of wide screen (e.g. 16:9). In this display system, the side walls (as contrast to the top and bottom walls in FIG. 4) of the integrator are designed as movable walls that move in the same manner as the movable top and bottom walls described with reference to FIG. 4, while the top and the bottom walls are non-movable walls. Such an integrator can also achieve the aspect ratio modification. For example, with such an integrator with the side walls being movable, a display system with the native resolution of 1280×768 (e.g. useful for displaying 720p high-definition video) can present 1024×768 format display materials.

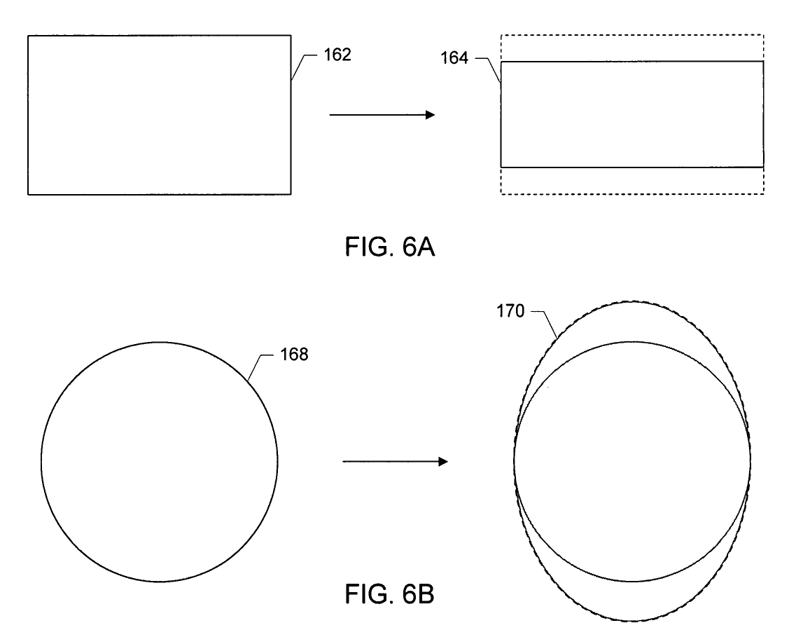

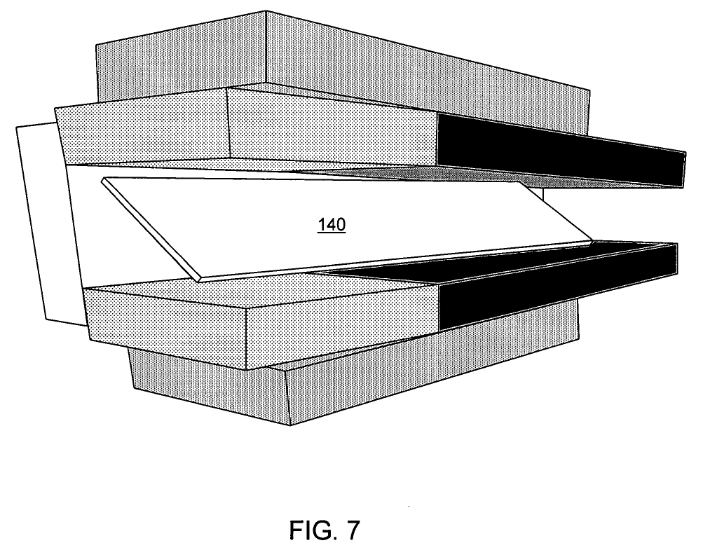

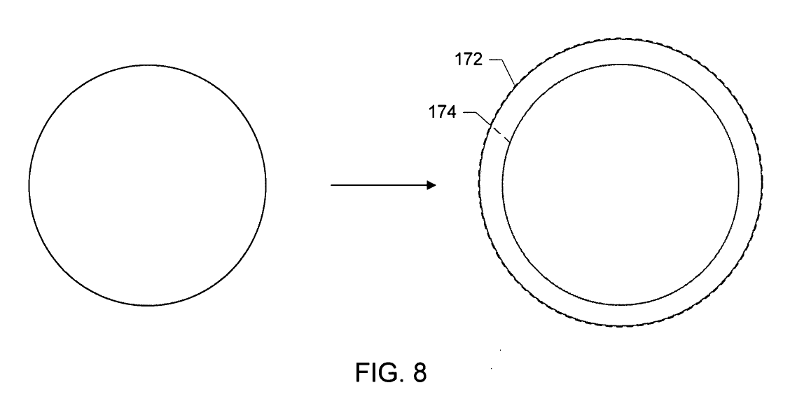

During the course of aspect ratio transformation as the light beam traveling through the integrator, the angular distribution of the light beam may be modified spontaneously. For example, the aspect ratio of the illumination area is transformed from 162 to 164 as shown in FIG. 6A. During the aspect ratio transformation, the circular angular distribution 168 in FIG. 6B at the entrance of the light integrator is transformed into oval angular distribution 170 in FIG. 6B. That is, the angular distribution is expanded in the vertical direction (the direction along which the movable walls of the integrator move), while the angular distribution remains intact in the horizontal direction (the normal direction of the non-movable side walls of the integrator). This angular redistribution arises from the accumulation of the angle increment after each reflection of the light beam by the titled top or the titled bottom walls. However, many current display systems using spatial light modulators desire uniform and homogeneous illumination with circular angular distribution. For this reason, beam splitter 140, which can be a partially reflective plate, can be provided within the integrator tunnel, as shown in FIG. 7. Specifically, light splitter 140 is inserted into the tunnel of the light integrator. All exposed surfaces (i.e. the top, bottom, and the side surfaces) of the light splitter are reflective surfaces. Light beam incident onto these surfaces are reflected into different directions. As a consequence, the light beams that are reflected only between the top and bottom interior surfaces in the absence of the light splitter can thus be reflected the interior surfaces of the side walls; and the light beams that are reflected only between the interior surfaces of the side walls in the absence of the light splitter can thus be reflected by the interior surfaces of the top and bottom walls of the integrator in the presence of the light splitter. Because the light beam accumulates angle increment after each reflection by the interior surface of the top or the bottom titled movable portion, and the reflection by the interior surfaces of the fixed side walls does not introduce extra angle variation, redirection of the light beams within the integrator by the reflections on the light splitter's surfaces result in an uniform angle increment for all light beams propagating through the integrator. Consequently, the angular distribution (e.g. 172 in FIG. 8) at the exit aperture of the integrator may be expanded in area as compared to the angular distribution (e.g. 174 in FIG. 8) at the entrance of the integrator but remains circular in shape, as shown in FIG. 8. In fact, the light splitter as discussed above can be applied to any type of light integrators for modifying the unsymmetrical angular distributions therewith into symmetrical angular distributions. In these applications, the integrator may or may not have movable walls.

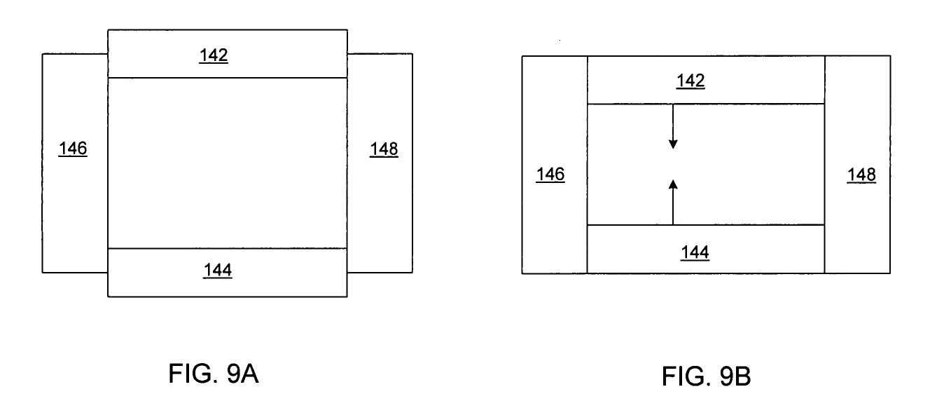

FIGS. 9A and 9B illustrate a light integrator according to another embodiment of the invention. Unlike the integrator discussed above, the integrator in FIGS. 9A and 9B does not have movable walls that tilt during operation, which may cause unsymmetrical angular distribution. Rather, the integrator comprises movable walls that displace in parallel instead of tilt around pivot axes. Specifically, the integrator comprises non-movable walls 146 and 148, and movable walls 142 and 144. The interior surfaces of the walls are highly reflective to the light beams propagating through the integrator. The movable walls 142 and 144 each can displace along the vertical direction such that the vertical dimension of the interior cross-section of the integrator is variable, as shown in FIG. 9B.

Referring to FIG. 9B, the top and bottom are movable in parallel towards the center of the integrator so as to form an exit aperture having a size compatible to the aspect ratio of the desired image. In this approach, opposite walls of the integrator remain parallel during operation-causing no undesired asymmetric angular distribution. Of course, the integrator can be constructed such that the side walls 146 and 148 are movable, while the top and bottom walls 142 and 144 are non-movable. Alternatively, all walls can be movable walls. According to the embodiment of the invention, displacements of the movable walls are identical or symmetric. Specifically, it is preferred that, the movable walls of the integrator are opposite to the center of the integrator, and the displacements of the opposite movable walls are identical. However, it is not absolutely required that the opposite movable walls are moved simultaneously. Instead, they can be moved at different times. The displacements of the movable walls can be achieved by imposing driving forces to separate movable walls, such as 142 and 144.

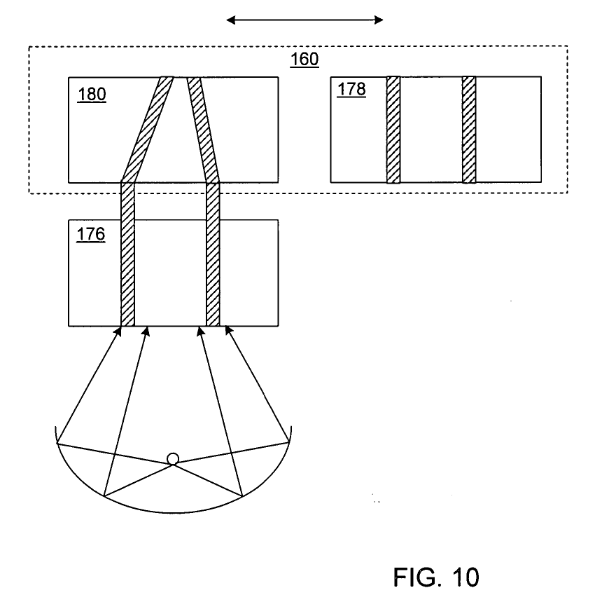

Referring to FIG. 10, another approach to delivering illumination light beams from the light source to the spatial light modulator according to the invention is demonstrated therein. In this approach, two integrator components 178 and 180 are juxtaposed in parallel and can be attached to movable base 160. Light integrator component 178 can be a regular light integrator with or without tapered walls, but has an exit aperture of a first aspect ratio, such as 4:3. Light integrator component 180 can be a light integrator having movable walls as shown in FIG. 4 or FIG. 9, and has an exit aperture of a second aspect ratio, such as 16:9. During operation, one of the two light integrator components is moved to the exit of integrator component 176, which collects the light beam. An advantage of this approach is that the first integrator component (i.e. 176) does not move and receives the focus of the lamp, which is the hottest point after the arc bulb of the light source. This aids in both safety and thermal management.

Referring back to FIG. 1, in a further embodiment of the invention, lens 108 between light integrator 104 and spatial light modulator 112 can be replaced by a anamorphic optical system or an imaging system (i.e. imaging the integrator onto the spatial light modulator) comprising cylindrical lens elements that allow for modifying the aspect ratio of the illumination area on the spatial light modulator by, for example, rotating and/ort translating the lens elements. Alternatively, the light pipe can be rotated to change the aspect ratio, optionally in combination with anamorphic lens elements.

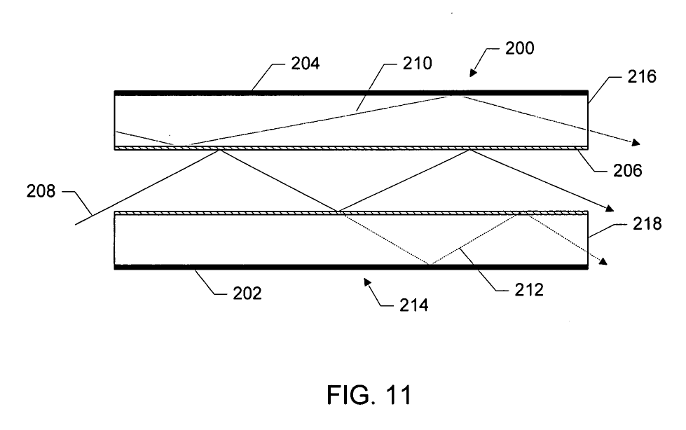

In accordance with an embodiment of the invention, the exterior surfaces of the light integrator can be coated with light absorbing films, or light reflecting layers, or a combination thereof. FIG. 11 illustrates a cross-sectional view of an exemplary such light integrator. Referring to FIG. 11, walls 200 and 214 of the light integrator may be non-movable or movable walls of the light integrator. Alternatively, these two walls, each or both may comprise portions that are movable as discussed earlier. In any configuration, each wall comprises an interior reflective film on the interior surface of the wall and an exterior film on the exterior surface of the wall. For example, reflective film 206, preferably has a reflectivity of 85% or higher, 90% or higher, or 97% or higher to the incident light, is deposited on the interior surface of wall 200. Film 210, which can be a light absorbing film, or reflective film similar to reflective film 206, or a combination thereof, is deposited on the exterior surface of wall 200. When film 204 is a light absorbing layer, it is preferred that it absorbs 80% or more, or 90% or more, or 99% or more of the light incident thereto. When film 204 is a multilayered structure comprising a light absorbing layer and a reflective layer, the layers can be deposited in any order on the exterior surface of wall 200.

In operation, incident light 208 from the light source, such as light source 102 in FIG. 1 of the display system travels through the entrance of the light integrator, bounces between the interior reflective surfaces on the walls of the light integrator, and escapes the light integrator at the exit aperture. When the interior reflective surfaces on the walls are not ideal (e.g. do the reflectivity is not 100%), a portion of the light incident thereto may pass through the interior reflective surface and leak into the wall, such as light 212 in wall 214. In the absence of film 202, which can be a reflective film, or a light absorbing film or any combination thereof, light 212 will pass through wall 214 and escape the light integrator from the wall. Such escaped light from the wall, instead from the exit aperture of the light integrator then travels within the display system unpredictably, resulting in undesired light scattering, which in turn degrades the quality of the displayed image. For this reason, film 212, comprising a light absorbing layer can be deposited for absorbing light traveling within wall 214. For the same reason, film 204 is deposited on the exterior surface of wall 200.

In fact, the light absorbing film on the exterior surfaces of the walls of the light integrator can be used to absorb light that enters into the wall from the side and travels within the wall, such as light 210 in wall 200. Without light absorbing film 204, light 210 may escape the light integrator from wall 200 into the display system, causing unpredictable light scattering.

In another embodiment of the invention, films 204 and/or 202 can be light reflective layers. The light traveling within the walls can be reflected between the interior and exterior reflective surfaces and then escaped at sides 216 and 218 of the wall 200 and 212, as shown in the figure. These light beams escaped from the sides can be used to illuminate the spatial light modulator. Or alternatively, can be dumped by, for example, light absorbing films coated on the side walls 216 and 218.

It will be appreciated by those of skill in the art that new and useful methods and apparatus for illuminating spatial light modulators of display systems have been described herein. In view of many possible embodiments to which the principles of this invention may be applied, however, it should be recognized that the embodiments described herein with respect to the drawing figures are meant to be illustrative only and should not be taken as limiting the scope of invention. Those of skill in the art will recognize that the illustrated embodiments can be modified in arrangement and detail without departing from the spirit of the invention. For example, the embodiments of the invention can also be implemented in light integrators having non-rectangular interior cross-sections. In these implementations, the integrators can be constructed such that the movable walls are disposed symmetrically and opposite to the center of the integrator. Alternatively, the integrator may have only one movable wall. As yet another example, the movable wall of the integrator may have more than one movable portion. If multiple movable portions constitute a movable wall, the movable portions can be connected consecutively. Specifically, the interior surfaces of the movable portions are connected so as to form a continuous reflecting surface for the light beams inside the integrator. Moreover, the gap between adjacent portions of a wall is minimized to avoid light leakage. Therefore, the invention as described herein contemplates all such embodiments as may come within the scope of the following claims and equivalents thereof.

1. A light integrator for use in a display system employing a spatial light modulator, comprising: a plurality of reflective surfaces, one of which is movable between at least two positions that are not parallel to each other.

2. The integrator of claim 1, wherein one of the plurality of reflective surface is operable to rotate along an axis that is between an entrance and exit aperture of the light integrator.

3. The integrator of claim 1, wherein an edge of said one reflective surface is attached to an end of a non-movable surface.

4. The integrator of claim 3, wherein said one reflective surface is operable to rotate along an axis within the reflective surface and passing through the attachment point.

5. The integrator of clam 1, wherein the plurality of reflective surfaces form a tunnel in which a light beam propagates.

6. The integrator of claim 1, wherein another one of the plurality of reflective surfaces is pivotable.

7. The integrator of claim 6, wherein said another movable reflective surface is positioned symmetrically to said one movable surface around the center of the integrator.

8. The integrator of claim 1, wherein the plurality of reflective surfaces form a rectangular cylinder.

9. The integrator of claim 8, wherein two of the reflective surfaces are movable and are positioned opposite to each other.

10. The integrator of claim 9, wherein the two opposite and movable reflective surfaces are on the top and bottom of the rectangular cylinder.

11. The integrator of claim 8, wherein the rectangular cylinder has an entrance and exit aperture, wherein the entrance and the exit aperture have different aspect ratios.

12. The integrator of claim 11, wherein the entrance has an aspect ratio of about 4:3.

13. The integrator of claim 1, wherein the entrance has an aspect ratio of about 16:9.

14. The integrator of claim 11, wherein the exit aperture has an aspect ratio of about 4:3.

15. The integrator of claim 11, wherein the exit aperture has an aspect ratio of about 16:9.

16. The integrator of claim 1, wherein the plurality of surfaces comprises a first set of non-movable reflective surfaces and a second set of surfaces at least one of which is movable, wherein the first set of reflective surfaces form a first rectangular cylinder, and second set of reflective surfaces form a second rectangular cylinder that is in connection with the first cylinder.

17. The integrator of claim 16, wherein the movable surface has a pivoting axis at a joint of the first and second cylinder.

18. The integrator of claim 16, wherein the surfaces of the first set are surfaces of a set of plates that do not deform around a surface temperature of an arc lamp in operation in a display system employing a spatial light modulator.

19. The integrator of claim 16, wherein the plurality of reflective surfaces comprises a set of reflective surfaces of a light splitter that is disposed within the rectangular cylinder.

20. The integrator of claim 1, wherein the movable surface is operable to displace in parallel.

21. A light integrator for use in a display system employing a spatial light modulator, comprising: a pair of non-movable walls and a pair of pivotable walls with each wall having a reflective surface for reflecting light, wherein each of the pivotable walls comprises at least two states that are not parallel to each other.

22. The integrator of clam 21, wherein the walls form a tunnel in which a light beam propagates, and the reflective surfaces of the walls form an interior reflective surface of the tunnel.

23. The integrator of claim 21, wherein the movable walls each have a pivoting axis along which the movable wall can pivot.

24. The integrator of claim 21, wherein the pair of movable walls are positioned opposite to each other.

25. The integrator of claim 1, wherein the pairs of walls form a rectangular cylinder.

26. The integrator of claim 25, wherein the two opposite movable walls are on the top and bottom of the rectangular cylinder.

27. The integrator of claim 26, wherein the rectangular cylinder has an entrance and exit aperture, wherein the entrance and the exit aperture have different aspect ratios.

28. The integrator of claim 27, wherein the entrance has an aspect ratio of 4:3.

29. The integrator of claim 27, wherein the entrance has an aspect ratio of 16:9.

30. The integrator of claim 27, wherein the exit aperture has an aspect ratio of 4:3.

31. The integrator of claim 27, wherein the exit aperture has an aspect ratio of 16:9.

32. The integrator of claim 27, wherein the rectangular cylinder is conjoint wit another rectangular cylinder.

33. The integrator of claim 32, wherein the movable wall has a pivoting axis at a joint of the first and second cylinder.

34. The integrator of claim 32, herein said another rectangular cylinder does not deform around a surface temperature of an arc lamp in operation in a display system employing a spatial light modulator.

35. The integrator of claim 27, further comprising: a light splitter that is disposed within the rectangular cylinder.

36. The integrator of claim 21, wherein the movable walls are operable to displace in parallel.

37. An illumination system for illuminating a spatial light modulator of a display system, comprising:
a light source providing a light beam; and
a light integrator of claim 1.

38. An illumination system for illuminating a spatial light modulator of a display system, comprising:
a light source providing a light beam; and
a light integrator of claim 21.

39-67. (canceled)
